(19) United States
(12) Patent Application Publication
(10) Pub. No.: US 2015/0051071 A1
(43) Pub. Date: Feb. 19, 2015

(54) PRINTED MATTER AND METHOD OF MANUFACTURING THE SAME, AND INSPECTION METHOD OF PRINTING APPARATUS

(71) Applicant: KYOCERA Corporation, Kyoto-shi, Kyoto (JP)

(72) Inventors: Shouichi Yoshidome, Kirishima-shi (JP); Nari Gotou, Kirishima-shi (JP); Ryouta Imanishi, Landkreis Esslingen (DE)

(73) Assignee: KYOCERA CORPORATION, Fushimi-ku, Kyoto (JP)

(21) Appl. No.: 14/383,712

(22) PCT Filed: Mar. 7, 2013
(86) PCT No.: PCT/JP2013/056377

§ 371 Date: Sep. 8, 2014

(30) Foreign Application Priority Data
Mar. 7, 2012 (JP) 2012-050556

(51) Int. Cl. B41M 5/124; B41M 5/00

(52) U.S. Cl. CPC B41M 5/1246; B41M 5/0029
USPC 503/226; 347/16

(57) ABSTRACT

[Object] To provide a printed matter with which an inspection of a printing apparatus is easily performed.

[Solution] An inspection of a printing apparatus is performed by: manufacturing a printed matter which includes a first film and a second film, at least one of which is transparent, and in which a liquid that is used to print by the printing apparatus is interposed between the first film and the second film; and inspecting the printed matter.

### TECHNICAL FIELD

The present invention relates to a printed matter and a method of manufacturing the same, and an inspection method of a printing apparatus.

### BACKGROUND ART

In recent years, a recording apparatus, in which an inkjet recording method is used, such as an inkjet printer or an inkjet plotter is widely used not only in a printer for general consumers but also in industrial usage such as in the forming an electronic circuit, in manufacturing of a color filter for a liquid crystal display, and in manufacturing of an organic EL display.

In addition, as an inspection method of such an inkjet-type printing apparatus, a method is known, in which, using a transparent ink, a volume of a discharged droplet is evaluated (for example, refer to PTL 1).

In addition, in the normal ink, dye or pigment is put in a solvent, and the solvent of the ink is used to print on the recording medium is dried or volatilized, and then the dye and the pigment remain on the recording medium.

### CITATION LIST

### Patent Literature

PTL 1: Japanese Unexamined Patent Application Publication No. 2004-345213

### SUMMARY OF INVENTION

### Technical Problem

However, even in trying to inspect the print quality of a printing apparatus using an image printed with a transparent ink, there has been a problem in that it is difficult to keep the print state where the transparent liquid state is kept on the recording medium.

In addition, in trying to obtain a printed matter on which the ink is kept in a liquid state, since the liquid component of the ink is volatilized or dried, there has been a problem in that it is difficult to keep the ink in the liquid state.

Therefore, an object of the present invention is to provide a printed matter on which the ink is kept as the liquid state and a method of manufacturing the same, and an inspection method of a printing apparatus.

### Solution to Problem

A printed matter according to the present invention includes a first film and a second film where at least one of which is transparent. A liquid is interposed between the first film and the second film.

In addition, a method of manufacturing the printed matter according to the present invention includes: preparing the first film and the second film at least one of which is transparent; printing with the liquid on any one film of the first film and the second film; and bonding the other film to a surface side of the one film where the liquid is used to print in a state where the liquid maintains the liquid state.

Furthermore, an inspection method of a printing apparatus according to the present invention includes inspecting the inspection sheet which is manufactured by preparing a first film and a second film, at least one of which is transparent, printing a liquid by the printing apparatus on one film of the first film and the second film, and bonding the second film to a surface side of the one film where the liquid is used to print in a state where the liquid maintains the liquid state.

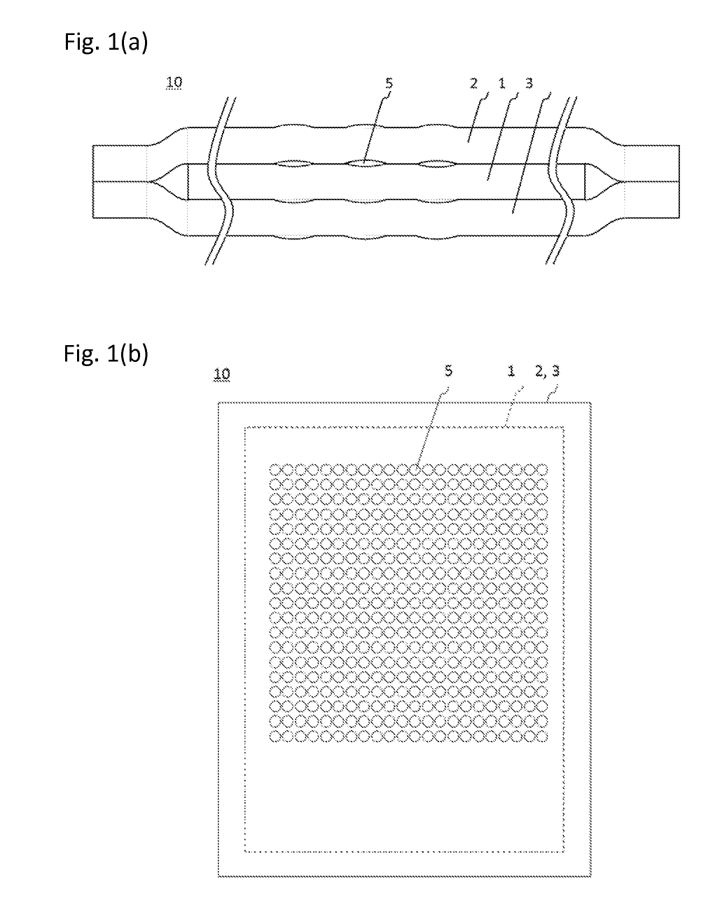

### BRIEF DESCRIPTION OF DRAWINGS

[FIG. 1] FIG. 1(a) is a vertical cross-sectional view of a printed matter in an embodiment of the present invention, and FIG. 1(b) is a plan view of the printed matter illustrated in FIG. 1(a).

### DESCRIPTION OF EMBODIMENTS

In the present embodiment, in an inspection method of a printing apparatus on which a liquid discharging apparatus such as a liquid discharging head is mounted, the inspection is performed using a printed matter in which a liquid is used to print on one of the films by the printing apparatus, the other film is bonded to the surface where the liquid is used to print, and then, the liquid between the films keeps the liquid state. The print state is evaluated from the result of actual printing. In this way, for example, in a case where the printing apparatus is a printing apparatus on which a liquid discharging apparatus that discharges droplets from a number of discharge holes is mounted whether or not the liquid is discharged from the discharge holes can be simply checked. In addition, by inspecting whether or not a streak or unevenness occurs in the printing result, it is possible to check the accuracy of discharging such as an amount of discharging or a direction of discharging.

In order to make an accurate and fast inspection, the liquid may be used to print by the printing apparatus in various patterns.

Patterns by which a specific evaluation for the print state can be performed are exemplified as follows. In order to check whether or not the ink is discharged from each discharge hole or whether or not the discharging direction is deviated greatly, a pattern is used, in which, with a droplet discharged from a single discharge hole, continuous arrays of pixels (for example, approximately 50 dots or more) having a length that can be verified by a visual inspection method is printed with spacing a gap (for example, approximately 10 to 20 dots) by which the adjacent arrays of pixels can be identified using a visual inspection method in a direction orthogonal to the transport direction of the recording medium. In this way, in a case where the discharging is not performed or there is a discharge hole of which the discharge direction is deviated greatly, it can be distinguished at a glance. In addition, it can also be checked by performing a solid printing whether or not the discharging is performed from each discharge hole. In the solid printing, the printing is performed by continuously discharging the ink for 50 dots or more from all the discharge holes used in the solid printing. Since the ink does not land on a portion corresponding to a discharge hole that does not discharge the ink, the recording medium is exposed and the appearance changes compared to a portion corresponding to a discharge hole that discharges the ink, and thus, it is possible to detect the discharge hole that does not discharge the ink. In addition, the inspection may be performed by printing an image that is easy to check when the printing accuracy is low.

As the liquid used in the printed matter described above, similar to the inspection of the printing apparatus in the related art, an ink actually used or a liquid close thereto can be used, but more preferably, a transparent liquid (hereafter, referred to as simply liquid) may be used. The term “transparent” here indicates a printing-performed droplet in which color is not visually identified, and further, indicates a liquid in which there is little residue after the printing and the evaporation, and in such a case where the printing is performed on a white sheet, and the residue after the evaporation cannot be visually recognized. In other words, it means a colorless liquid (the term “colorless” does not indicate “having no color” but, in a general sense, indicates that the color does not include white, grey, black, or the like).

In addition, as the printed matter described above, the printed matter illustrated in FIG. 1(a) and FIG. 1(b) can be used. This printed matter is used as an inspection sheet of the printing apparatus. FIG. 1(a) is a vertical cross-sectional view of a printed matter and FIG. 1(b) is a plan view of the printed matter. In FIG. 1(b), an area of a liquid 5 on the printed matter 10 is illustrated larger than actual.

The printed matter 10 includes a first film 1 and a second film 2, at least one of which is transparent, and a transparent liquid 5 which is printed by the printing apparatus is interposed between the first film 1 and the second film 2. The liquid 5 fills a space between the first film 1 and the second film 2 or causes an ink-receiving layer provided on the a surface of the first film 1 or the second film 2 to be slightly swollen. Specifically, between the first film and the second film, there exists a liquid which is different from the dyes. Using printed matter 10 like this as an inspection sheet, it is possible to inspect the print state of the liquid 5. In a portion where the first film 1 and the second film 2 are in contact with each other and in a portion where the liquid 5 is interposed between the first film 1 and the second film 2, since the states of the interfaces or the entire thicknesses are different from each other, it is possible to check the print state by a simple method such as visual checking, projecting, or expanding by a binocular microscope from the transparent film side. In this way, it is possible to check the state of the printing apparatus subject to being inspected. For example, it is possible to check whether or not there is a discharging from the discharge hole of the liquid discharging apparatus on the printing apparatus. In addition, by printing the pattern to check for the printing accuracy, it is possible to inspect the degree of a streak and unevenness.

In addition, since the transparent liquid 5 is kept between the first film 1 and the second film 2, it is possible to keep the inspection sheet as a record of the print state. In addition, it is also possible to attach the inspection sheet to the printing apparatus as a certification of the performance of the printing apparatus.

A material for the first film 1 and the second film 2 is not specifically limited as long as it is deformable to bend to a certain extent, and a plastic material such as polyethylene terephthalate (PET) can be used. If a material through which the liquid 5 does not transmit is used, it is not only possible to inspect after the discharge but also possible to keep the state as it is, as described above. A film having a thickness of approximately 20 μm to 200 μm can be used. By using the thickness of 20 μm or more, the strength can be assured and can be easily handled by using the thickness of 200 μm or less, the liquid 5 interposed between the films can easily be checked. Both the first film 1 and the second film 2 may be transparent.

In addition, if the liquid 5 is in a state of being interposed between the first film 1 and the second film 2 like this, the printed matter 10 can be stored with the liquid 5 keeping the liquid state. In this way, on the printed matter 10, it is possible to record an image. In a case of a color ink other than a transparent one, it is possible to similarly obtain the printed matter 10 in which the liquid state is kept. By the liquid 5 keeping the liquid state, color different from that in a case where the liquid is dried and only the pigment or dye remains can be obtained. For example, it is possible to create a state of transparency.

If the first film 1 and the second film 2 are bonded by a resin layer, since the liquid 5 is easily held between the bonded first film 1 and the second film 2, the storage stability is improved. In addition, at the time of bonding, since the liquid 5 does not spread around, the first film 1 and the second film 2 are bonded around the liquid 5 and thus, the liquid 5 can be fixed without moving from the original printed position or with a small change in size. In addition, in order to decrease the movement or a change in size, it is preferable to, after the printing of the liquid 5, overlap the first film 1 and the second film 2 and cause the overlapped films to pass through the rollers to be bonded in one direction. At this time, it is preferable to heat the rollers such that the films are easily bonded with the resin layer. If the temperature of the rollers is too high, the liquid 5 may evaporate, therefore, it is preferable to set the temperature to be equal to or lower than the boiling point of the liquid 5 +20° C.

The description will be made with the film on which the printing apparatus performs printing as the first film 1. In the first film 1 which is a film for printing, it is preferable that the printing surface be surface-treated such that the liquid 5 is less likely to spread compared to the surface opposite to the printing surface. The surface-treating of the printing surface such that the liquid 5 is less likely to spread, is particularly useful in a case where the printing is performed by the liquid discharging apparatus causing the liquid droplet 5 to land. In this way, at the time of bonding the second film 2, it is possible to decrease the change in size or movement of the liquid 5. The surface-treatment is performed by forming an ink receiving layer on the first film 1. As the ink receiving layer, water-soluble resin or an inorganic pigment fixed by resin is used depending on the liquid 5 in use. In addition, if such an ink receiving layer is formed, there is a difference in state of the interfaces: the interface where the ink receiving layer and the resin layer are bonded, and the interface where the liquid 5 is interposed and thus the ink receiving layer and the resin layer are not bonded, or the penetration of the resin layer into the ink receiving layer is small. Therefore, the portion where the liquid 5 exists is clearly identified. The portion where the liquid 5 exists, for example, exhibits a white color.

In addition, if a portion of the first film 1 or the second film 2 with which the liquid 5 is in contact reacts with the liquid 5 and thus, the color is developed or changed, then, the print state can easily be recognized. For example, if fine particles of cobalt chloride are input to the ink receiving layer and the liquid 5 which includes water is used, the cobalt chloride reacts with water and the color thereof is changed to blue from pink. Therefore, the print state of the liquid 5 can easily be recognized visually. The portion where the fine particles of cobalt chloride are input may be a portion other than the ink receiving layer but a portion with which the liquid 5 is in contact, for example, may be an adhesive layer of the second film 2 on the first film 1 side.

As another material of which the color is changed by the reaction, firstly the liquid 5 is made to be weakly alkaline or weakly acidic, and then, the material of which the color is changed by the change of pH may be put into the ink receiving layer and/or the resin layer. Depending on the material of the portion in the printing apparatus with which the liquid 5 is in contact, the weak alkalinity may be preferable because the weak alkalinity hardly damages the printing apparatus. As the materials of which the color is changed, phenolphthalein, bromothymol blue, neutral red, naphtholphthalein, and cresol red may be used.

In addition, an end portion of the first film 1 of the printed matter 10 may be in a state of being interposed between the second film 2 and a third film 3 so as not to be exposed. In this way, the volatilization of the liquid 5 from the end portion between the first film 1 and the second film 2 can be suppressed, and thus, the storage state can be improved. If the third film 3 is provided so as to cover not only the end portion of the first film 1 but also the entire first film 1, then the storage state can be further improved. Specifically, the third film 3 is bonded to the surface opposite to the surface of the first film 1 where the liquid 5 exists. Then, the second film 2 and the third film 3 are larger than the first film 1, and the second film 2 and the third film 3 are bonded at the outside of the first film 1. In this way, the entire portion of the first film 1 is in a state of being wrapped by the second film 2 and the third film 3, and thus, it is possible to improve the retention of the liquid 5 in the printed matter 10. It is possible to use the third film 3 having the same material and the same thickness as those of the first film 1 and the second film 2. At this time, in a case of inspection by viewing from the second film 2 side, at least the second film 2 is transparent and in a case of inspection by viewing from the first film 1 side, at least one of the first film 1 and the third film 3 is transparent.

In addition, if a fourth film 4 such as a sheet having a dark color, for example, a black or brown colored sheet is interposed between the third film 3 and the first film 1, and the first film 1 and the second film 2 are transparent and by inspection from the second film 2 side, it is possible to perform the inspection in a state where the difference of the state of interfaces described above is clear.

The inspection sheet described above is useful in a case where the evaluation is performed while leaving the solvent component as well as in a case of transparent liquid. That is, in a case of inspecting the printing apparatus with a liquid including solvent and dye or a liquid including solvent and pigment, if the inspection sheet described above is used, the inspection can be performed in a state of including the liquid as a solvent.

The inspection of the printing apparatus can be performed as follows. It is preferable that the transparent liquid 5 used in the inspection not include the pigment and the dye that exhibit colors and not have a retained residue after drying. As the liquid 5, water, alcohol, or the like can be used. Those can be prepared for inspection only, or can be prepared both for a cleaning solution and a preservative solution. In addition, in order to use the liquid both for a cleaning solution and a preservation solution or in order to be close to the characteristics of the liquid actually used, a surfactant or other components may be added within the range of no color exhibition or no residue remaining. If it is possible to perform the inspection with the liquid 5 which can be used both for cleaning solution and the preservation solution, the change process of putting-in the liquid 5 can be reduced, and thus, the process for manufacturing the printing apparatus can be simplified.

Hereinafter, as a device for landing the liquid 5 on the first film 1, a method for inspecting the liquid discharging apparatus mounted on the printing apparatus will be described. If the first film 1 is a printing film which is surface-treated such that the transparent liquid 5 to be printed is difficult to spread on the surface thereof, it can be difficult to make the change in the position or the size of the liquid 5 until the inspection. For this, for example, an OHP sheet for inkjet printing can be used. If the MJOHPS1N from Seiko Epson Corporation is used, when the second film 2 is bonded, the portion where the liquid 5 exists changes to white, and thus, the visual recognition of the position where the liquid 5 exists can be improved.

The liquid 5 is discharged under conditions according to the inspection items from the liquid discharging apparatus subject to being inspected, and the first film 1 and the discharge head are relatively moved, if necessary, and then, the liquid 5 is landed on the first film 1. An amount of the droplet discharged from the liquid discharging apparatus depends on the inspection items. However, by landing the liquid 5 equal to more than 10 pL (pico litter), preferably 20 pL or more, and particularly 30 pL or more on a single position, the visual recognition of the position where the liquid 5 exists can be improved. Depending on the inspection items, when an amount of the droplet discharged from the liquid discharging apparatus, a plurality of droplets may be caused to land on almost the same point, and then the inspection may be performed.

The second film 2 on one surface where the resin layer is formed is bonded to the first film 1 where the liquid 5 lands. Here, other than bonding the first film 1 and the second film 2, the first film 1 may be bonded such that the first film 1 is interposed between the third film 3 having one surface where the resin layer is formed, and the second film 2 described above, or a dark colored sheet overlapped on the first film 1 and the surface of the first film 1 opposite to the surface where the liquid 5 is landed may be bonded such that the colored sheet is interposed between the second film 2 and the third film 3. As the second film 2 and the third film 3, a laminated film may be used. There are various methods for bonding, but if the bonding is performed by the films passing through the heated rollers, the difference of the positions and the sizes of the liquid 5 after the bonding and at the time of landing can be reduced. In addition, by pressurizing and heating, a part of the resin layer of the second film 2 soaks into the surface-treated ink receiving layer of the first film 1. Since a part of the resin layer of the second film 2 does not soak into the portion where the liquid 5 exists or soaks in a small amount, the state of the interface is different, and thus, the difference between the position where the liquid 5 exists, and the periphery thereof can be clear. In addition, in this way, the color of the position where the liquid 5 exists becomes white, and it is easy to see. In a case where the main component of the liquid 5 is water, in order to easily change the color to white, it is preferable to set the temperature of the rollers as 100° C. to 110° C.

By the inspection sheet manufactured in this way, the position where the liquid 5 exists can be visually checked, or the inspection can be performed with a simple method such as applying an oblique light. Therefore, the inspection for the liquid discharging apparatus can be simplified. In addition, the liquid 5 interposed between the first film 1 and the second film 2 can be stored for a long time such as one year or more, and the liquid 5 can be maintained as that of an inspection result of the liquid discharging apparatus or can be attached to the liquid discharging apparatus for indicating the guarantee of the performance.

In addition, by a method similar to that described above, it is possible to perform the printing of the printed matter 10 other than the inspection sheet.

### REFERENCE SIGNS LIST

1. first film (film for printing)
2. second film
3. third film
5. liquid
10. printed matter

1. A printed matter comprising:
a first film and a second film, at least one of which is transparent,
wherein a liquid is interposed between the first film and the second film.

2. The printed matter according to claim 1,
wherein the liquid is transparent.

3. The printed matter according to claim 1,
wherein the liquid is used to print a specific pattern.

4. The printed matter according to claim 1,
wherein the liquid is discharged from the liquid discharging apparatus, and
wherein the printed matter is an inspection sheet that inspects a print state of the liquid discharging apparatus.

5. The printed matter according to claim 1,
wherein the first film and the second film are bonded around the portion where the liquid is interposed.

6. The printed matter according to claim 1, further comprising:
a resin layer on a surface side of at least one film of the first film and the second film, which is in contact with the liquid.

7. The printed matter according to claim 1, further comprising:
a resin layer on the surface side of one film of the first film and the second film, which is in contact with the liquid; and
a surface-treated layer in which the liquid is difficult to spread compared to the surface opposite to the surface which is in contact with the liquid, on a surface side of the other film which is in contact with the liquid.

8. The printed matter according to claim 1, further comprising:
a third film,
wherein the first film is interposed between the second film and the third film such that an end portion of the first film is not exposed.

9. The printed matter according to claim 8,
wherein the first film and the second film are transparent, and
wherein a dark colored fourth film is interposed between the first film and the third film.

10. The printed matter according to claim 7,
wherein the portion of the resin layer or the surface-treated layer, which is in contact with the liquid, reacts with the liquid and the color is changed.

11. The printed matter according to claim 7,
wherein cobalt chloride is included at least in the portion of the resin layer or the surface-treated layer, which is in contact with the liquid, and
wherein the liquid includes water.

12. A method of manufacturing a printed matter, comprising:
preparing a first film and a second film, at least one of which is transparent;
printing with a liquid on one film of the first film and the second film; and
bonding the other film to a surface side of the one film where the liquid is used to print in a state where the liquid maintains the liquid state.

13. The method of manufacturing a printed matter according to claim 12,
wherein the liquid is transparent.

14. An inspection method of a printing apparatus, comprising:
inspecting an inspection sheet which is manufactured by:
preparing a first film and a second film, at least one of which is transparent;
printing with a liquid by the printing apparatus on one film of the first film and the second film; and
bonding the other film to the one film side where the liquid is used to print in a state where the liquid maintains the liquid state.

15. The inspection method of the printing apparatus according to claim 14,
wherein the liquid is transparent.

16. The inspection method of the printing apparatus according to claim 14,
wherein the printing apparatus is a liquid discharging apparatus.
